(19) United States
(12) Patent Application Publication
(10) Pub. No.: US 2015/0278400 A1
(43) Pub. Date: Oct. 1, 2015

(54) HYBRID VARIATIONAL SOLVING IN CAD MODELS

(71) Applicant: Siemens Product Lifecycle Management Software Inc., Plano, TX (US)

(72) Inventors: Howard Charles Duncan Mattson, Cambridge (GB); Douglas Joseph King, Peterborough (GB); Paul Jonathon Sanders, Cambridge (GB)

(73) Assignee: SIEMENS PRODUCT LIFECYCLE MANAGEMENT SOFTWARE INC., Plano, TX (US)

(21) Appl. No.: 14/229,029

(22) Filed: Mar. 28, 2014

(51) Int. Cl. G06F 17/50; G06T 17/00

(52) U.S. Cl. CPC G06F 17/50; G06T 17/00

(57) ABSTRACT

Methods for product data management and corresponding systems and computer-readable mediums. A method includes receiving a CAD model with a plurality of elements, each element having a plurality of features. The method includes receiving a CAD operation to be performed on the plurality of elements and performing a variational solve on a first one of the plurality of elements according to the CAD operation to produce an edited first element. The method includes calculating corresponding CAD operations for the remaining plurality of elements according to the edited first element and a relationship between the edited first element and the remaining elements to produce an edited plurality of elements. The method includes storing the edited first element and the edited plurality of elements in the CAD model.

### TECHNICAL FIELD

The present disclosure is directed, in general, to computer-aided design, visualization, and manufacturing systems (“CAD” systems), product lifecycle management (“PLM”) systems, and similar systems, that manage data for products and other items (collectively, “Product Data Management” systems or PDM systems).

### BACKGROUND OF THE DISCLOSURE

PDM and CAD systems manage PLM and other data. Improved systems are desirable.

### SUMMARY OF THE DISCLOSURE

Various disclosed embodiments include methods for product data management and corresponding systems and computer-readable mediums. A method includes receiving a CAD model with a plurality of elements, each element having a plurality of features. The method includes receiving a CAD operation to be performed on the plurality of elements and performing a variational solve on a first one of the plurality of elements according to the CAD operation to produce an edited first element. The method includes calculating corresponding CAD operations for the remaining plurality of elements according to the edited first element and a relationship between the edited first element and the remaining elements to produce an edited plurality of elements. The method includes storing the edited first element and the edited plurality of elements in the CAD model.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIGS. 2A and 2B illustrate a pattern spacing change CAD operation in accordance with disclosed embodiments;

FIGS. 3A and 3B illustrate a pattern shape change CAD operation in accordance with disclosed embodiments;

FIGS. 4A and 4B illustrate an instancing CAD operation in accordance with disclosed embodiments;

FIGS. 5A and 5B illustrate a mirror CAD operation in accordance with disclosed embodiments;

FIGS. 6A and 6B illustrate a domain-specific construction CAD operation in accordance with disclosed embodiments;

FIGS. 7A and 7B illustrate graph representations of processes in accordance with disclosed embodiments;

FIGS. 8A and 8B illustrate an example of a CAD model and corresponding graph in accordance with disclosed embodiments;

FIGS. 9A-9C illustrate an example of a CAD model and corresponding graph in accordance with disclosed embodiments; and

FIG. 10 illustrates a flowchart of a process in accordance with disclosed embodiments.

### DETAILED DESCRIPTION

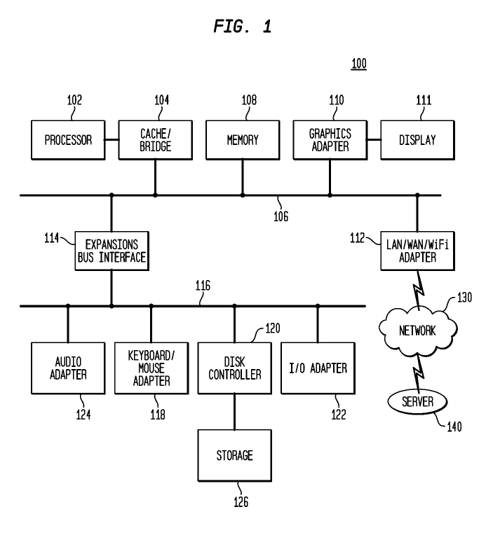

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

A variational system such as those implemented in the Siemens Synchronous Technology software products will typically employ a constraint solver. Often this module will be designed to be general in application and so not necessarily tuned to the particular use. In variational systems, the behavior of underconstrained entities is often uncontrollable and not guaranteed, or can be even random or semi-random, changing on each invocation or when a new version of the software is created, producing different results in apparently similar situations. Further, the performance will often suffer due to a lack of application knowledge, structure, or intent within a particular model. Additionally, for large models, there is a simple interface cost of adding it all to the solver. The actual observed effect can be considerably worse than this would suggest and it can be that models of moderate size can generate a very large number of constraints that are not solvable by a general solver in reasonable time. This is exacerbated if the requirement is to solve repeatedly in real time.

Disclosed embodiments include systems and methods for performing CAD operations outside of the variational solver to improve efficiency and consistency. Disclosed techniques lead to substantially fewer entities being “solved,” which significantly reduces the overhead and also reduces the chances or frequency of unacceptable behavior. Disclosed techniques also lead to the CAD system having more ability to control behavior using the variational solver and leveraging the solution across the wider model, since with far fewer entities being solved, adding a few more constraints is not detrimental to performance.

FIG. 1 depicts a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed systems and methods include a high-level process for identifying CAD operations that will be applied to multiple elements of a CAD model, then performing the CAD operation, including a variational solve, on only one or a few of the multiple elements, and thereafter applying a consistent non-variational edit to the remaining elements. This produces the overall desired result without performing a variational solve on each of the individual elements. To distinguish between operations in the description below, “solve” (and variations) refers to operations performed by a variational solver, which are naturally computationally intensive, and “calculate” (and variations) refers to computations performed by the CAD system mathematically or otherwise without being performed by the variational solver.

Note that while the specific examples below may be made to two-dimensional (2D) or three-dimensional (3D) models specifically, the techniques disclosed herein can be generally applied to any 2D or 3D model.

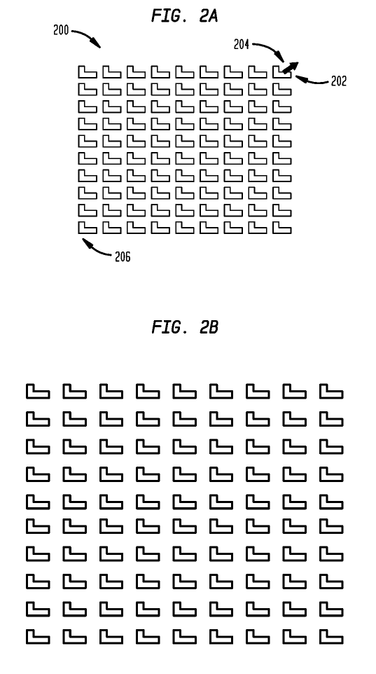

Disclosed embodiments can perform a pattern spacing change CAD operation. FIGS. 2A and 2B illustrate a pattern spacing change CAD operation in accordance with disclosed embodiments.

Often a CAD system user desires to change the spacing of a pattern, such as the pattern of CAD elements illustrated in the CAD model 200 of FIG. 2A. The system can receive a user input of such an operation, such as the user “dragging” a corner element 202 into a new position, as indicated by arrow 204. In such a case, all the other elements need to move into new positions.

In a conventional system, each of the elements is solved individually, by passing each element to the variational solver and applying appropriate constraints, to allow the spacing to change, as shown in FIG. 2B. In this example, the edit to each of 100 elements in the model would be separately solved by the variational solver. This process is computationally intensive and inefficient.

Disclosed embodiments, however, can add just the dragged first element 202 plus a fixed opposite corner 206 and calculate the other 98 elements proportionally to produce the same result illustrated in FIG. 2B. That is, only element 202 is passed to the variational solver to be solved for its new position. After that solve is completed, the system uses the new position of element 202 in combination with the fixed position of opposite corner 206 to directly calculate the proportional locations of each of the other elements, without passing each of these to the variational solver.

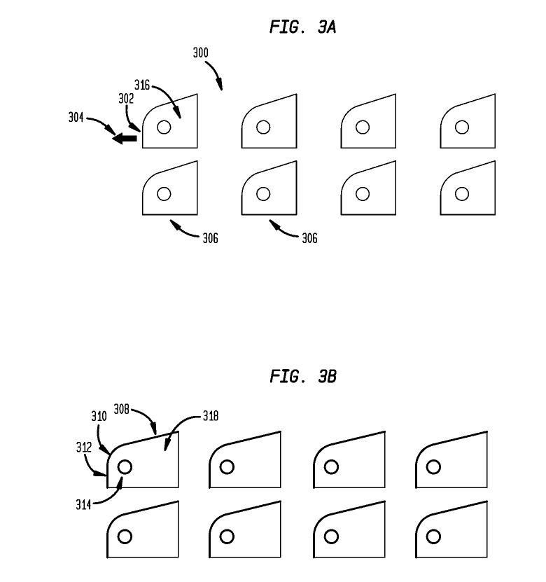

Disclosed embodiments can perform a pattern shape change CAD operation. FIGS. 3A and 3B illustrate a pattern shape change CAD operation in accordance with disclosed embodiments.

Often a CAD system user desires to change shape of the similar individual elements pattern, such as the pattern of CAD elements 306 illustrated in the CAD model 300 of FIG. 3A. For example, the CAD system can receive a user input to change the shape of a pattern element, perhaps by dragging a feature of an element. Such an edit may require the other features in the element to move accordingly and the other elements in the pattern to also change shape accordingly.

In this example, a user drags the line feature 302 of one element 316 to the left, as indicated by arrow 304, to produce an edited first element 318 as illustrated in FIG. 3B. The other features connected or constrained to this line must change accordingly, and the same must happen for all the other affected features, to produce the result illustrated in FIG. 3B.

This may be accomplished in a conventional system by adding all of these elements and their features to the solver and adding all the required constraints in each member, too, resulting in 32 entities (the affected features of each of the elements) being added, constrained, and solved in this example.

Disclosed embodiments can achieve the same result much more efficiently. Instead of solving all 32 entities, just the four required entities in the selected first element are added and solved, including the lines 308 and 312, arc 310, and hole 314, so that the variational solver produces the new shape of the element. Then, the system can calculate the remaining 24 entities (the features of the remaining elements) by simply applying the same transform as their selected member counterparts. That is, each line, arc, and circle is calculated and moved according to the four-entity variational solve performed for the single element.

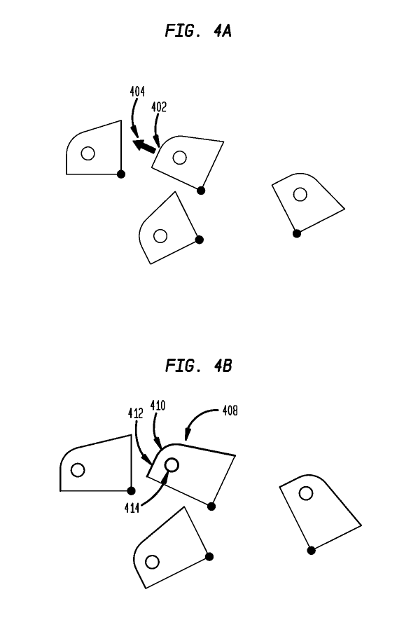

Disclosed embodiments can perform an instancing CAD operation. FIGS. 4A and 4B illustrate an instancing CAD operation in accordance with disclosed embodiments. Often a CAD system user desires to change the shape of multiple similar elements having similar features, even when these elements are not in a regular pattern or structure. Instancing is similar to pattern shape change described above, except that there is no regularity in the transforms from one element to another.

In this example, a user drags the line feature 402 of one element to the left, as indicated by arrow 404. The other features connected or constrained to this line must change accordingly, and the same must happen for all the other affected features, to produce the result illustrated in FIG. 4B.

This may be accomplished in a conventional system by adding all of these elements and their features to the solver and adding all the required constraints in each member, too, resulting in 32 entities (the features of each of the elements) being added, constrained, and solved in this example.

Disclosed embodiments can achieve the same result much more efficiently. Instead of solving all 32 entities, just the four required entities in the selected first element are added and solved, including the lines 408 and 412, arc 410, and hole 414, so that the variational solver produces the new shape of the element. Then, the system can calculate the remaining 24 entities (the features of the remaining elements) by simply applying the same relative transform as their selected member counterparts in the solved element. That is, each line, arc, and circle is calculated and moved according to the four-entity variational solve performed for the single element, taking into account their relative rotations.

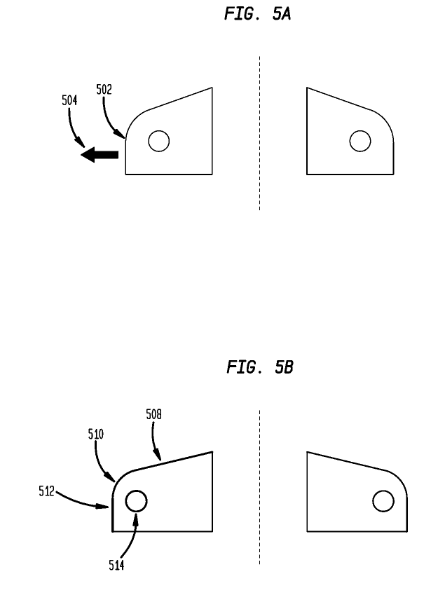

Disclosed embodiments can perform a mirror CAD operation. FIGS. 5A and 5B illustrate a mirror CAD operation in accordance with disclosed embodiments. Often a CAD system user desires to change the shape of multiple similar elements having mirrored shapes and location. A mirror or symmetric situation uses a reflection transform rather than a rigid transform, but the principle is the same as those described above.

In this example, a user drags the line feature 502 of one element to the left, as indicated by arrow 504. The other features connected or constrained to this line must change accordingly, and corresponding but mirrored edits must happen for the affected mirrored features, to produce the result illustrated in FIG. 5B.

As in the examples above, a conventional system would require each element and its affected features to be separately solved, which is inefficient.

The same adapting constraints are logically present on both sides. Disclosed embodiments can perform the edit by solving one side and calculate the corresponding changes on the other side of the nominal “mirror.”

Instead of solving all entities in each element, just the four required entities in the selected first element are added and solved, including the lines 508 and 512, arc 510, and hole 514, so that the variational solver produces the new shape of the element. Then, the system can calculate the remaining 24 entities (the features of the mirrored elements) by simply applying the same relative reflected transform as their selected member counterparts in the solved element. That is, each line, arc, and circle is calculated and moved according to the four-entity variational solve performed for the single element, taking into account the mirror relationship.

Disclosed embodiments have the additional benefit of forcing the calculation of the transforms to be exact reflections of each other, which solving may not necessarily do.

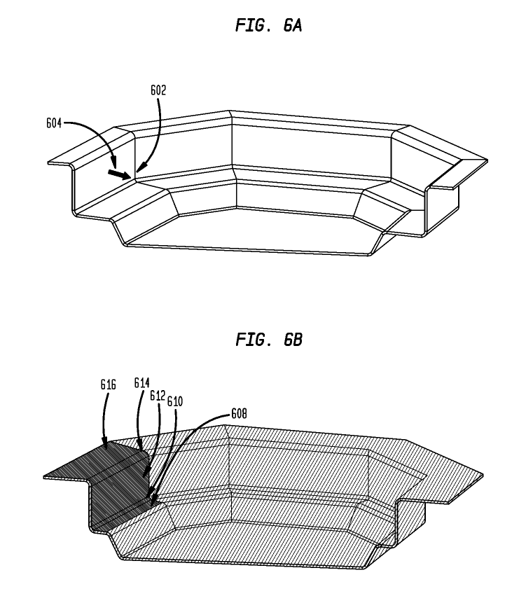

Disclosed embodiments can perform a domain-specific construction CAD operation. FIGS. 6A and 6B illustrate a domain-specific construction CAD operation in accordance with disclosed embodiments. Particular domains and applications will have many specific constructions that will contain far more regularity than is able to be efficiently represented in a variational solver.

In the example of FIG. 6A, a ‘contour flange’ is a sheet metal construction which contains many compound ‘flanges’ with similar profiles arranged along a contour of a plate. Consider, in this example, moving element 602 to the right as indicated by arrow 604, which narrows the “ledge” and expands the “rim.”

To maintain the profile similarity around the contour, all the corresponding elements must change in the same way which involves moving the selected element and adapting its immediate neighborhood plus similarly moving and adapting all the corresponding elements.

A conventional system would be required to solve every element of the CAD model, which is computationally intense and inefficient.

Disclosed embodiments, however, can solve just the selected element and its adapting neighbour elements, and calculate the remainder using the knowledge of the transform of each relative to the solved one.

In this example, the system only solves the first element 610 (the moved element) and its neighboring elements 608, 612, 614, and 616. The remainder of the elements in the CAD model are calculated using known constraints, relationships, and transforms with respect to solved elements.

This is a highly specialised construction and further edits and modes of operation are possible and each has its own formulation of minimal solver plus calculation involving a large amount of engineering requirements and knowledge by the application that would be unreasonable for a general variational solver to acquire.

The operations and examples discussed above are areas where large performance gains can be made. However, with any system that programmatically adds constraints, a large number of unstructured constraints can rapidly build up giving similar performance and behavior advantages by applying disclosed techniques.

In isolation, most of the simpler geometric constraints can be calculated including offset, identical, coplanar, parallel, perpendicular, distance, angle, etc. Calculating changes outside a general variational solver also allows some level of support for geometry types not readily handled by typical solvers such as splines, chamfers, blends and procedural geometry in general.

Many common constraint-solving situations, including but not limited to those discussed above, can be handled outside a solver. In general, however, disclosed embodiments can perform CAD operations efficiently involving a combination of constructs such as patterns, mirrors, domain specific constructions, plus any number of connective simpler constraints required by the particular system, by solving only a subset of the affected entities and computing the corresponding changes to the remaining entities.

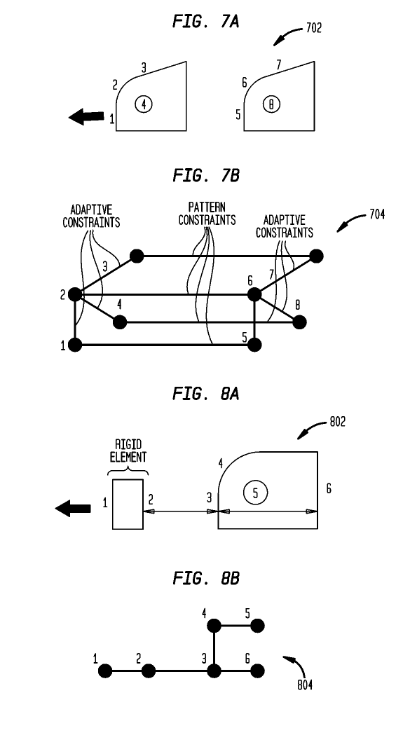

To explain the approach a graph representation is useful. FIGS. 7A and 7B illustrate graph representations of processes in accordance with disclosed embodiments. FIG. 7A illustrates a simple pattern shape change example of CAD model 702, having two elements that each have multiple features, and FIG. 7B illustrates a corresponding graph representation 704. The various numbered features of FIG. 7A are shown as correspondingly-numbered nodes in the graph of FIG. 7B, and the edges between the nodes represent various constraints such as adaptive constraints and pattern constraints.

The graph representation 704 can show and store what is being solved and what is being calculated along with the constraint connections. In a conventional process, all nodes and edges are solved.

Using a combined solve/calculation process as described herein, only nodes 1, 2, 3, and 4, and their connecting edges, are solved. The remaining nodes and edges are calculated.

For these complex constructions, an amount of domain or application knowledge can be used to allow this reformulation as a small solved piece and a larger calculation portion.

In general there will also be portions of the graph made up of unstructured constraints. FIGS. 8A and 8B illustrate an example of a CAD model 802 and corresponding graph 804 in accordance with disclosed embodiments. The various numbered features of FIG. 8A are shown as correspondingly-numbered nodes in the graph of FIG. 8B, and the edges between the nodes represent various constraints such as adaptive constraints, and unstructured constraints.

In such a case, the system can perform a graph traversal process to reduce the number of nodes that must be solved. In this process, the system can look for leaf nodes that can be calculated from their neighbors and apply this incrementally to determine all the nodes and edges that can be calculated rather than solved. In this example, assume the rigid element including lines 1 and 2 (represented in FIG. 8B by nodes 1 and 2) is moved to the left. The system can first determine that leaf nodes 5 and 6 represent elements that, based on their constraints, can be completely calculated from the positions of nodes 4 and 3, respectively. The system can then determine that node 4 can also be calculated from node 3. The system can then determine that node 3 can be calculated from node 2, and then that node 2 can be calculated from node 1. By determining which nodes can be calculated from each other, the system can determine that only node 1—edge 1 in FIG. 8A—must be solved, and the remaining nodes (and corresponding elements in FIG. 8A) can be calculated.

Various implementations can allow the system or user to choose which constraint types and situations to perform as calculations and this is therefore a tunable parameter in the method. Disclosed embodiments can also address various type of connection situations, including ambiguity, leaf nodes, and loops.

In various embodiments, the system can automatically address ambiguous constraints or relationships between elements. It is easier to perform the required calculation on constraint types that unambiguously define the result, such as identical, concentric, mirror, pattern, offset and others. In some cases, however, the constraints or relationships may have multiple possible characterizations. Calculating those that require a choice of solution, such as determining whether to preserve tangency and parallel relationships, can be more complex, but various embodiments can allow the system to define the default behavior consistently. A general solver will not usually allow this level of control.

Sometimes a solver will allow further constraints to be added to more fully define behavior, but this will come at a performance cost. However, if a majority of the model is calculated as described herein and the solved portion is small, then it becomes tractable to add further constraints to that small set to better define the result.

It is generally easier to reform leaf nodes, and this includes nodes that become leaf nodes in the incremental approach.

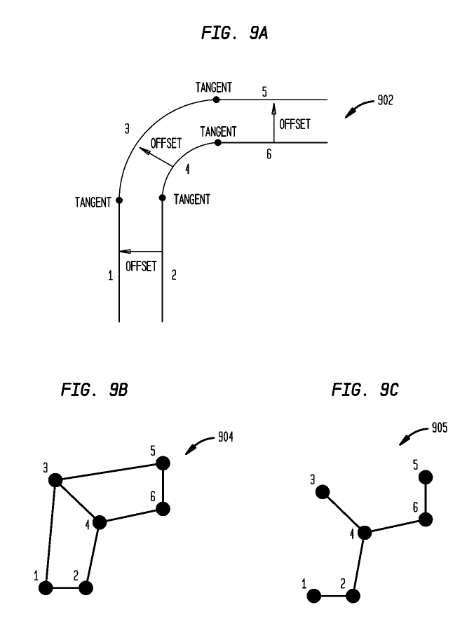

Sections of the graph containing loops will not generally be reformed using disclosed graphing techniques except for some special cases. The example FIG. 7B was an example of a special case of this. FIGS. 9A-9C illustrate another example of a CAD model and corresponding graph where offset entities are connected by tangent fillets, including CAD model 902 and corresponding graph 904 in accordance with disclosed embodiments. The various numbered features of FIG. 9A are shown as correspondingly-numbered nodes in the graph of FIG. 9B, and the edges between the nodes represent various constraints and relationships such as offsets and tangency relationships.

Graph 904 contains loops, but we can remove two of the tangents as redundant, so the edge between nodes 1 and 3 is removed since it is redundant of the tangency relationship between nodes 2 and 4, and the edge between nodes 3 and 5 is removed since it is redundant of the tangency relationship between nodes 4 and 6. This loop-elimination process, based on redundancy in constraints or relationships between nodes, results in graph 905 in FIG. 9C. This then allows the graph traversal process described above to be performed.

Disclosed embodiments can therefore be used to reform a sufficient amount of the graph or model into calculation steps to improve performance and behavior properties. The actual amount of graph converted in this way will depend on the application preferences.

Some advantages of this method include improved performance by reducing the size of the solved graph, improved behavior consistency since often the same solver choice is replicated throughout by calculation, improved behavior control by choosing solutions in the application allows additional heuristics and domain decisions, improved behavior control by making the addition of further defining constraints a tractable option, and extensibility to additional geometry types, changes of geometry type, procedural elements and other constraint and geometry types not supported by the variational solver.

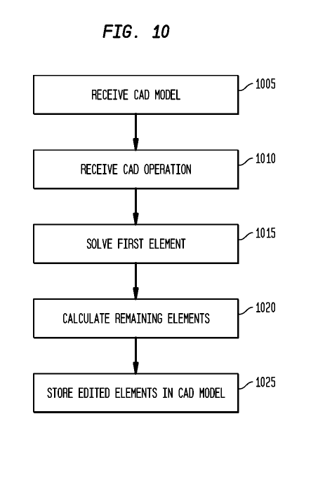

FIG. 10 depicts a flowchart of a process in accordance with disclosed embodiments that may be performed, for example, by a CAD, PLM, or PDM system, referred to generically as the “system” below, and can be implemented as a data processing system 100.

The system receives a CAD model with a plurality of elements, each element having a plurality of features (1005). “Receiving,” as used herein, can include loading from storage, receiving from another device or process, receiving via an interaction with a user, or otherwise. The CAD model can be a 2D model or a 3D model.

The system receives a CAD operation to be performed on the plurality of elements (1010).

The system performs a variational solve on a first one of the plurality of elements according to the CAD operation to produce an edited first element (1015). The CAD operation can be a pattern spacing change operation, a pattern shape change operation, an instancing operation, a mirror operation, a domain-specific construction operation, or other operation.

The system calculates corresponding CAD operations for the remaining plurality of elements according to the edited first element and a relationship between the edited first element and the remaining elements to produce an edited plurality of elements (1020). The relationship can be, for example, a constraint relationship, a spacing relationship, a mirror relationship, a transform, or other relationship. The edited plurality of elements can be produced without performing a variational solve on the remaining elements.

As part of calculating corresponding CAD operations, the system can represent one or more of the plurality of relationships in a graph representation with nodes representing features of the element and edges representing constraints or other relationships between individual ones of the features. The system can also perform a graph traversal process on the graph representation to reduce the number of nodes for which a variational solve is performed.

The system stores the edited first element and the edited plurality of elements in the CAD model (1025).

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC

What is claimed is:

1. A method for product data management, the method performed by a data processing system and comprising:
receiving a CAD model with a plurality of elements, each element having a plurality of features;
receiving a CAD operation to be performed on the plurality of elements;
performing a variational solve on a first one of the plurality of elements according to the CAD operation to produce an edited first element;
calculating corresponding CAD operations for the remaining plurality of elements according to the edited first element and a relationship between the edited first element and the remaining elements to produce an edited plurality of elements; and
storing the edited first element and the edited plurality of elements in the CAD model.

2. The method of claim 1, wherein the edited plurality of elements is produced without performing a variational solve on the remaining elements.

3. The method of claim 1, wherein the CAD operation is one of a pattern spacing change operation or a pattern shape change operation.

4. The method of claim 1, wherein the CAD operation is one of an instancing operation, a mirror operation, or a domain-specific construction operation.

5. The method of claim 1, wherein the relationship is at least one of a constraint relationship, a spacing relationship, a mirror relationship, or a transform.

6. The method of claim 1, wherein the system also represents one or more of the plurality of relationships in a graph representation with nodes representing features of the element and edges representing relationships between individual ones of the features.

7. The method of claim 6, wherein the system also performs a graph traversal process on the graph representation to reduce a number of nodes for which a variational solve is performed.

8. A data processing system comprising:
a processor; and
an accessible memory, the data processing system particularly configured to
receive a CAD model with a plurality of elements, each element having a plurality of features;
receive a CAD operation to be performed on the plurality of elements;
perform a variational solve on a first one of the plurality of elements according to the CAD operation to produce an edited first element;
calculate corresponding CAD operations for the remaining plurality of elements according to the edited first element and a relationship between the edited first element and the remaining elements to produce an edited plurality of elements; and
store the edited first element and the edited plurality of elements in the CAD model.

9. The data processing system of claim 8, wherein the edited plurality of elements is produced without performing a variational solve on the remaining elements.

10. The data processing system of claim 8, wherein the CAD operation is one of a pattern spacing change operation or a pattern shape change operation.

11. The data processing system of claim 8, wherein the CAD operation is one of an instancing operation, a mirror operation, or a domain-specific construction operation.

12. The data processing system of claim 8, wherein the relationship is at least one of a constraint relationship, a spacing relationship, a mirror relationship, or a transform.

13. The data processing system of claim 8, wherein the system also represents one or more of the plurality of relationships in a graph representation with nodes representing features of the element and edges representing relationships between individual ones of the features.

14. The data processing system of claim 13, wherein the system also performs a graph traversal process on the graph representation to reduce a number of nodes for which a variational solve is performed.

15. A non-transitory computer-readable medium encoded with executable instructions that, when executed, cause one or more data processing systems to:
receive a CAD model with a plurality of elements, each element having a plurality of features;
receive a CAD operation to be performed on the plurality of elements;
perform a variational solve on a first one of the plurality of elements according to the CAD operation to produce an edited first element;
calculate corresponding CAD operations for the remaining plurality of elements according to the edited first element and a relationship between the edited first element and the remaining elements to produce an edited plurality of elements; and
store the edited first element and the edited plurality of elements in the CAD model.

16. The computer-readable medium of claim 15, wherein the edited plurality of elements is produced without performing a variational solve on the remaining elements.

17. The computer-readable medium of claim 15, wherein the CAD operation is one of a pattern spacing change operation or a pattern shape change operation.

18. The computer-readable medium of claim 15, wherein the CAD operation is one of an instancing operation, a mirror operation, or a domain-specific construction operation.

19. The computer-readable medium of claim 15, wherein the relationship is at least one of a constraint relationship, a spacing relationship, a mirror relationship, or a transform.

20. The computer-readable medium of claim 15, wherein the system also represents one or more of the plurality of relationships in a graph representation with nodes representing features of the element and edges representing relationships between individual ones of the features, and performs a graph traversal process on the graph representation to reduce a number of nodes for which a variational solve is performed.
